(19) United States
(12) Patent Application Publication
(10) Pub. No.: US 2005/0248584 A1
(43) Pub. Date: Nov. 10, 2005

(54) Imaging system and image processing apparatus

(76) Inventors: Koji Takeo, Miyagi (JP); Yasuyuki Shindoh, Miyagi (JP); Noriyuki Terao, Miyagi (JP); Koji Oshikiri, Miyagi (JP); Atsuhiro Oizumi, Miyagi (JP); Satoru Numakura, Miyagi (JP); Junichi Ikeda, Miyagi (JP); Tohru Sasaki, Iwate (JP); Yutaka Maita, Miyagi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/121,039

(22) Filed: May 4, 2005

(30) Foreign Application Priority Data
May 10, 2004 (JP) 2004-139696
Jun. 7, 2004 (JP) 2004-168552

(51) Int. Cl. G09G 5/02

(52) U.S. Cl. 345/603

(57) ABSTRACT

An imaging system that implements a PCI Express high-speed serial interface system is disclosed in which a plurality of point-to-point simplex communication channels are established to realize a data communication network having a tree structure. The imaging system includes a PCI Express high-speed serial interface, and plural independent image processing units as end point devices of the tree structure that are connected by the PCI Express high-speed serial interface.

### BACKGROUND OF THE INVENTION

1. Field of the Invention

The present invention relates to an imaging system such as a scanner, a printer, a digital copier, or a multifunction printer (MFP). The present invention also relates to an image processing apparatus that is adapted to conduct predetermined image processes on image data.

2. Description of the Related Art

Generally, in an apparatus/system that handles data such as image data, a PCI bus is used as an interface between devices. However, problems such as racing and skew occur upon using the PCI bus, which realizes parallel transmission, and a sufficient transmission rate may not be obtained with the PCI bus when high speed/high resolution image processing is demanded. Accordingly, use of a high speed serial interface instead of a parallel interface such as the PCI bus is being contemplated. It is noted that standards such as IEEE 1394 and USB have conventionally been used to realize serial interfaces. However, serial interfaces according to such standards are inferior to the PCI bus with respect to the transmission rate, and also have disadvantages with respect to securing a scalable bus width, for example. In turn, use of the PCI Express (registered trademark) corresponding to a successor of the PCI bus as a high speed serial interface is being contemplated (e.g., see “Outline of the PCI Express Standard”, Interface, July 2003, pp. 80˜93).

FIG. 1 is a block diagram illustrating connections between devices of a digital copier machine 200 corresponding to a so-called multifunction printer according to the prior art. The digital copier machine 200 includes a CPU 201 that controls the operations of units within the digital copier machine 200, and a controller 203 corresponding to an ASIC (application specific integrated circuit) that is connected to the CPU 201 via a dedicated interface (I/F) 202. A system memory 204 for temporarily storing data such as image data, a hard disk drive (HDD) unit 205 for storing data such as image data, and an image processing unit 206 for conducting predetermined image processes on image data are connected to the controller 203 via the dedicated I/F 202. Also, a scanner 213, a plotter 214, and a communication I/F 215 for realizing communication with a network, and other multifunction printers 216 are connected to the controller 203 via a PCI parallel bus 211 and a general-purpose I/F 212. Also, image processing units 217 and 218 that realize predetermined image processes are connected to the scanner 213 and plotter 214, respectively, via the dedicated I/F 202.

According to the prior art, an image processing unit such as the image processing units 206, 217, and/or 218 corresponding to a DSP (digital signal processor), for example, that is used in an imaging system such as a scanner, a printer, a digital copier machine, or a MFP is designed to have image processing functions in accordance with the maximum performance or capabilities of the imaging system. Thereby, when the specifications of the imaging system are changed, the specifications of the image processing unit have to be changed as well. In other words, the image processing unit used in the prior art lacks versatility and flexibility, and/or may be inefficient in conducting certain image processes.

Also, in the prior art, the PCI bus 211 is used for transmitting a relatively large amount of image data, and thereby, the image data may take up the bus bandwidth so that additional functions may not be added to the image processing unit at a later stage. In other words improvements may not be made with respect to the computation capability of the image processing unit such as the image processing units 206, 217, and/or 218. Also, the bandwidth for the HDD unit 205 is limited, and improvements may not be made with respect to the performance of the HDD unit 205.

### SUMMARY OF THE INVENTION

Accordingly, it is an object of the present invention to provide an imaging system implementing a PCI Express high speed serial interface system to realize a versatile and flexible image processing unit.

It is another object of the present invention to prevent a decrease in productivity due to a bandwidth limitation of a magnetic storage unit in an image processing apparatus and enable improvements to be made in the performance of the magnetic storage unit by additionally implementing one or more magnetic storage units.

It is another object of the present invention to increase the image processing speed of an image processing apparatus, and/or to allow one or more new image processing functions to be added to the image processing apparatus at a later stage.

According to an aspect of the present invention, an imaging system is provided that implements a PCI Express high-speed serial interface system in which a plurality of point-to-point simplex communication channels are established to realize a data communication network having a tree structure, the imaging system including:
a PCI Express high-speed serial interface; and
a plurality of independent image processing units as end point devices of the tree structure that are connected by the PCI Express high-speed serial interface.

According to a preferred embodiment, the imaging system of the present invention further includes a scanner for reading image data and/or a printer for outputting a printed image based on the image data as another end point device of the tree structure that is connected by the PCI Express high-speed serial interface.

According to another preferred embodiment the imaging system of the present invention further includes a PCI Express switch to which the image processing units and the scanner and/or the printer are connected by the PCI Express high-speed serial interface.

According to another preferred embodiment of the present invention, the imaging units are configured to have identical image processing functions.

According to another preferred embodiment of the present invention, the image processing units are simultaneously activated or selectively activated depending on an image processing condition.

According to another preferred embodiment of the present invention, the imaging units are simultaneously activated in a case where a relatively large image is subject to image processing.

According to another preferred embodiment of the present invention, the image processing units are simultaneously activated in a case where image processing at a relatively high resolution is to be conducted.

According to another preferred embodiment of the present invention, image data subject to image processing are divided into image data sections with respect to a main scanning direction, and the image data sections are simultaneously processed by the image processing units.

According to another preferred embodiment of the present invention, image data subject to image processing are divided into image data sections with respect to a main scanning direction, and the image data sections are simultaneously processed by the image processing units.

According to another preferred embodiment of the present invention, the image processing units are configured to have differing image processing functions, and image data subject to image processing are relayed via the PCI Express high-speed serial interface and successively processed by the image processing units.

According to another aspect of the present invention, an image processing apparatus that is configured to conduct predetermined processes on image data is provided, the apparatus including:
a PCI Express bus and a PCI Express switch for realizing data transmission; and
plural magnetic storage devices corresponding to PCI Express end point devices that are connected to the PCI Express switch.

According to another aspect of the present invention, an image processing apparatus that is configured to conduct predetermined image processes on image data is provided, the apparatus including:
a PCI Express bus and a PCI Express switch for realizing data transmission; and
plural image processing circuits corresponding to PCI Express end points that are connected to the PCI Express switch.

According to a preferred embodiment of the present invention, the image processing circuits are configured to conduct a same type of image process.

According to another preferred embodiment of the present invention, the image processing circuits are configured to conduct different types of image processes.

### BRIEF DESCRIPTION OF THE DRAWINGS

FIG. 1 is a block diagram showing connections between devices of a digital copier according to the prior art;

FIG. 2 is a block diagram showing a structure of a PCI system;

FIG. 3 is a block diagram showing a structure of a PCI Express system;

FIG. 4 is a block diagram showing a structure of a desktop/mobile platform implementing the PCI Express;

FIG. 5 is a diagram showing a structure of a physical layer of a x4 PCI Express link;

FIG. 6 is a diagram showing an exemplary lane connection between devices;

FIG. 7 is a block diagram showing a logical structure of a switch;

FIG. 8A is a block diagram illustrating a PCI architecture;

FIG. 8B is a block diagram illustrating a PCI Express architecture;

FIG. 9 is a block diagram showing a layer structure of the PCI Express;

FIG. 10 is a diagram illustrating an exemplary format of a transaction layer packet;

FIG. 11 is a diagram illustrating a configuration space of the PCI Express;

FIG. 12 is a diagram illustrating the concept of a virtual channel;

FIG. 13 is a diagram illustrating an exemplary format of a data link layer packet;

FIG. 14 is a diagram illustrating byte striping of data in the x4 PCI Express link;

FIG. 15 is a table indicating definitions of link states used in the PCI Express link;

FIG. 16 is a time chart illustrating active state power management of the PCI Express link;

FIG. 17 is a block diagram showing a structure of an imaging system according to an embodiment of the present invention;

FIG. 18 is a block diagram illustrating active/inactive states of image processing units in the imaging system;

FIG. 19 is a block diagram showing a structure of an imaging system according to another embodiment of the present invention;

FIG. 20 is a block diagram showing connections between devices of a digital copier according to an embodiment of the present invention;

FIG. 21 is a block diagram illustrating the connection of HDD units to a switch of the digital copier;

FIG. 22 is a block diagram illustrating the connection of image processing units to a switch of the digital copier;

FIG. 23 is a diagram illustrating an exemplary operation realized in the structure shown in FIG. 22; and

FIG. 24 is diagram illustrating another exemplary operation realized in the structure shown in FIG. 22.

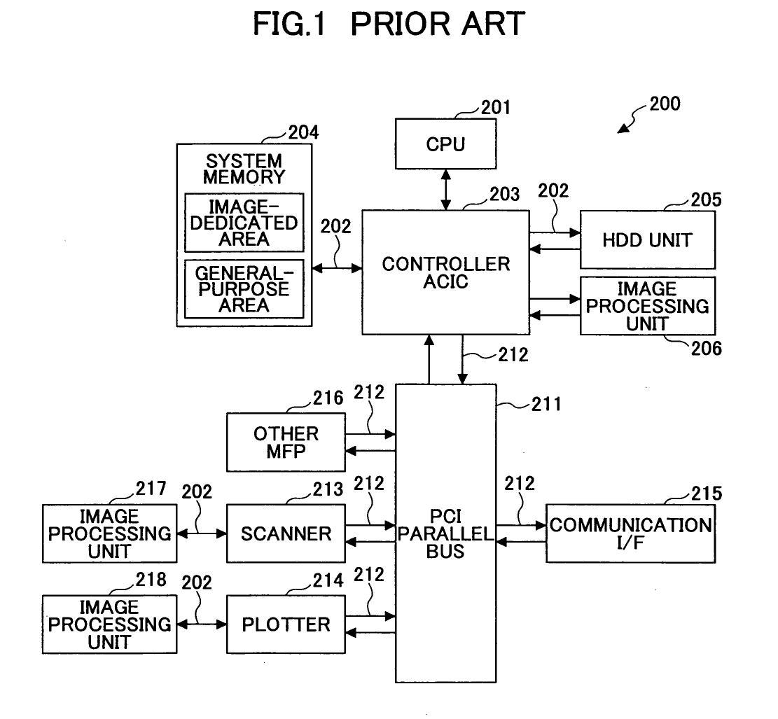

### DESCRIPTION OF THE PREFERRED EMBODIMENTS

In the following, preferred embodiments of the present invention are described with reference to the accompanying drawings.

First, a description of the PCI Express standard is given under the sections (Outline of the PCI Express Standard) through (Architecture of the PCI Express Standard). Then, an imaging system according to an embodiment of the present invention is described under the section (Imaging System), and a digital copier as an image processing apparatus according to an embodiment of the present invention is described under the section (Digital Copier).

(Outline of the PCI Express Standard)

The present invention relates to application of the PCI Express (registered trademark) corresponding to one type of high speed serial bus. In the following, an outline of the PCI Express standard is described with reference to excerpts of the document “Outline of the PCI Express Standard” cited above. It is noted that a high speed serial bus refers to an interface that enables data exchange at high speed (i.e., at least 100 Mbps) through serial transmission using one transmission channel.

The PCI Express, which is a successor of the PCI bus, is designed to be adaptable to computers in general. The PCI Express is characterized by realizing low voltage differential signal transmission, individual communication channels for point-to-point transmission/reception, packetized split transactions, and high scalability with respect to differences in link configurations, for example.

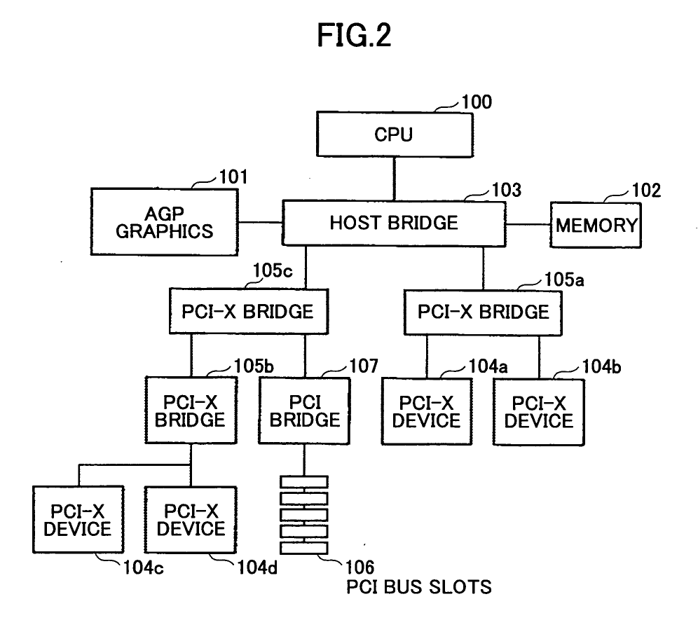

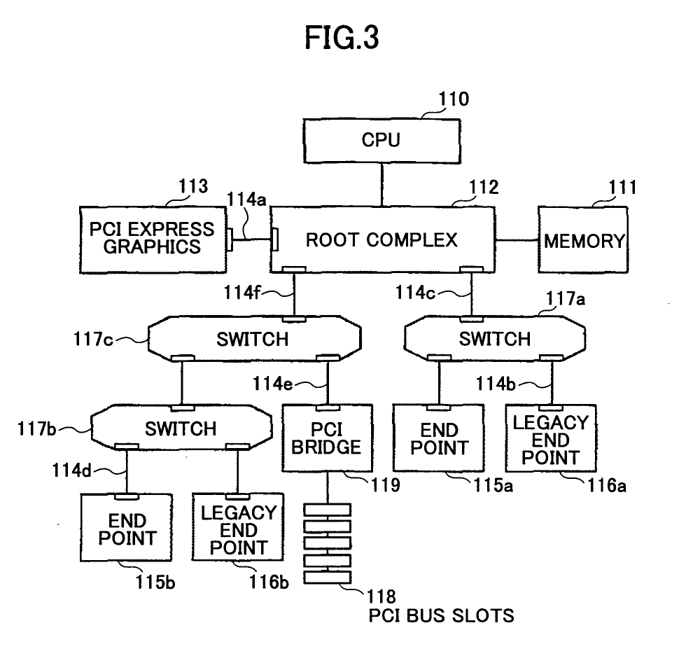

FIG. 2 is a block diagram showing an exemplary structure of a PCI system, and FIG. 3 is a block diagram showing an exemplary structure of a PCI Express system.

In the PCI system of FIG. 2, a CPU 100, an AGP graphics unit 101, and a memory 103 are connected to a host bridge 103, and a tree structure is realized by connecting PCI-X (PCI-Extended: upward compatibility standard of PCI) devices 104a and 104b to the host bridge 103 via a PCI-X bridge 105a, connecting PCI-X devices 104c and 104d to a PCI-X bridge 105c, which in turn is connected to the host bridge 103 via a PCI-X bridge 105c, and connecting PCI bus slots 106 to a PCI bridge 107, which in turn is connected to the host bridge 103 via the PCI-X bridge 105c.

In the PCI Express system of FIG. 3, a CPU 110 and a memory 111 are connected to a root complex 112, and a tree structure is realized by connecting a PCI Express graphics unit 113 to the root complex 112 via a PCI Express 114a, connecting an end point 115a and a legacy end point 116a via a PCI Express 114b to a switch 117a, which in turn is connected to the root complex 112 via a PCI Express 114c, connecting an end point 115b and a legacy end point 116b via a PCI Express 114d to a switch 117b, which in turn is connected to a switch 117c via a PCI Express 114e, connecting PCI bus slots 118 to a PCI bridge 119 which is connected to the switch 117c via the PCI express 114e, and connecting the switch 117c to the root complex 112 via a PCI express 114f.

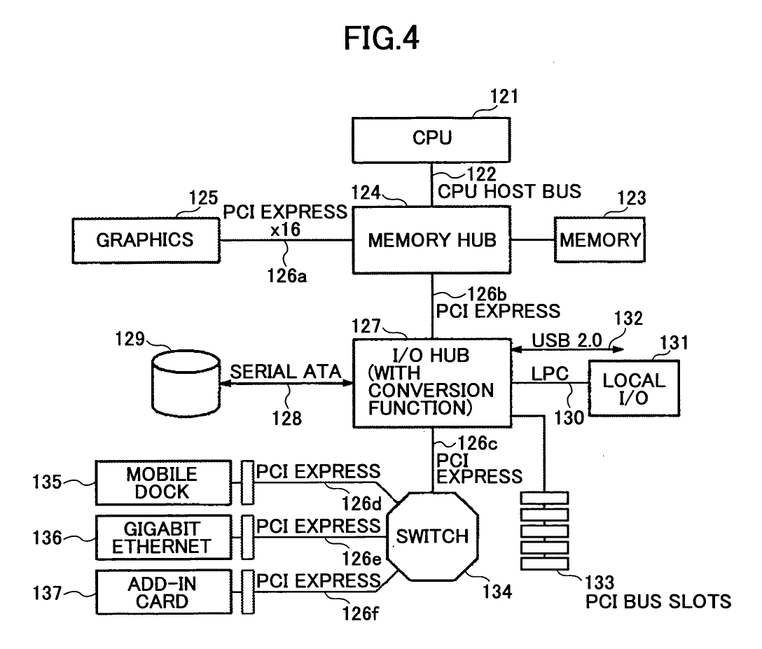

FIG. 4 is a block diagram showing an exemplary structure of a PCI Express platform that may be used in practice. The illustrated example of FIG. 4 may be used in a desktop/mobile application, for example. In the PCI Express system of FIG. 4, a CPU 121 is connected via a CPU host bus 122 to a memory hub 124 (corresponding to a root complex), which is connected to a memory 123. The memory hub 124 is connected to a graphics unit 125 via a x16 PCI Express 126a, and an I/O hub 127 having a conversion function via a PCI Express 126b. The I/O hub 127 is connected to a storage 129 via a Serial ATA 128, a local I/O 131 via a LPC 130, a USB 2.0 132, and PCI bus slots 133. Also, the I/O hub 127 is connected to a switch 134 via a PCI Express 126c, and the switch 134 is connected to a mobile dock 135, a gigabit Ethernet (registered trademark) 136, and an add-in card 137 via PCI Express 126d, 126e, and 126f, respectively.

It is noted that in a PCI Express system, interfaces such as PCI, PCI-X, and AGP used in the PCI system are replaced by the PCI Express, and a bridge is used to establish connection between PCI/PCI-X devices. Connection between chip sets is also realized through PCI Express connection, and buses such as IEEE 1394, Serial ATA, and USB 2.0 are connected to the PCI Express via I/O hubs.

(Elements of the PCI Express)

A. Port/Lane/Link

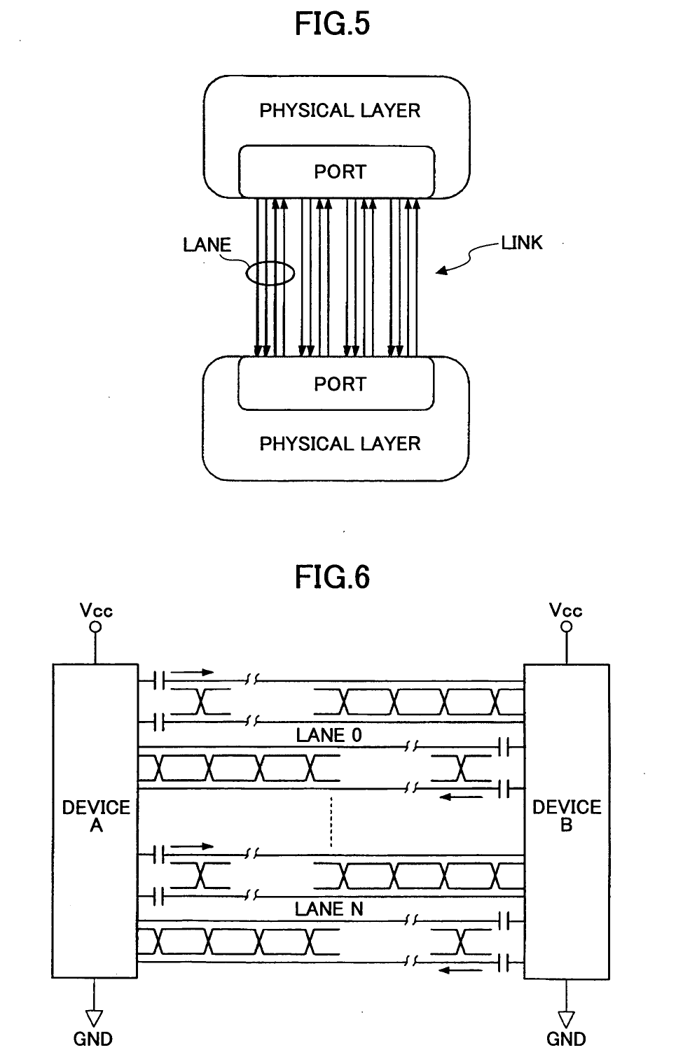

FIG. 5 is a diagram showing an exemplary physical layer structure of the PCI Express. Referring to FIG. 5, a port corresponds to a set of transmitters and receivers that are physically provided within the same semiconductor for establishing a link, the port realizing an interface for logically establishing one-to-one connection (point-to-point connection) between components. In the present example, the transmission rate is assumed to be 2.5 Gbps per direction (a transmission rate of 5 Gbps or 10 Gbps is expected to be realized in future applications). A lane corresponds to a set of 0.8 V differential signal pairs, including a transmission signal pair and a reception signal pair, for example. A link corresponds to a set of lanes establishing connection between two ports, and realizes a dual simplex communication bus between components. It is noted that a xN link is made up of N lanes, and in the present standard, the number N is defined as N=1, 2, 4, 8, 16, or 32. The illustrated example of FIG. 5 corresponds to a x4 link.

FIG. 6 is a diagram illustrating an arrangement of lanes establishing connection between device A and device B. By arranging the lane width N of the lanes to be adjustable, a scalable bandwidth may be obtained.

B. Root Complex

Referring back to FIGS. 3 and 4, the root complex 112, which is often referred to as a memory hub (e.g., memory hub 124 of FIG. 4) is arranged at an uppermost position of an I/O structure, and is configured to connect units such as a CPU and a memory subsystem to the I/O structure. The root complex 112 (or memory hub 124) includes at least one PCI Express port (root port) that is configured to realize an independent I/O layer domain. It is noted that in FIG. 3, three PCI Express ports are represented by small rectangles within the block representing the root complex 112. The I/O layer domain may correspond to a simple end point (e.g., end point 115a of FIG. 3), or be made up of plural switches and end points (e.g., end point 115b and switches 117b and 117c of FIG. 3).

C. End Point

An end point corresponds to a device having a type 00h configuration space header (i.e., a device other than a bridge device). Specifically, an end point may correspond to a legacy end point or a PCI Express end point. A primary difference between the two types of end points lies in the fact that the PCI Express end point corresponds to a BAR (base address register) that basically does not require an I/O port resource and thereby does not issue an I/O request. Also, it is noted that the PCI Express end point does not support a lock request.

D. Switch

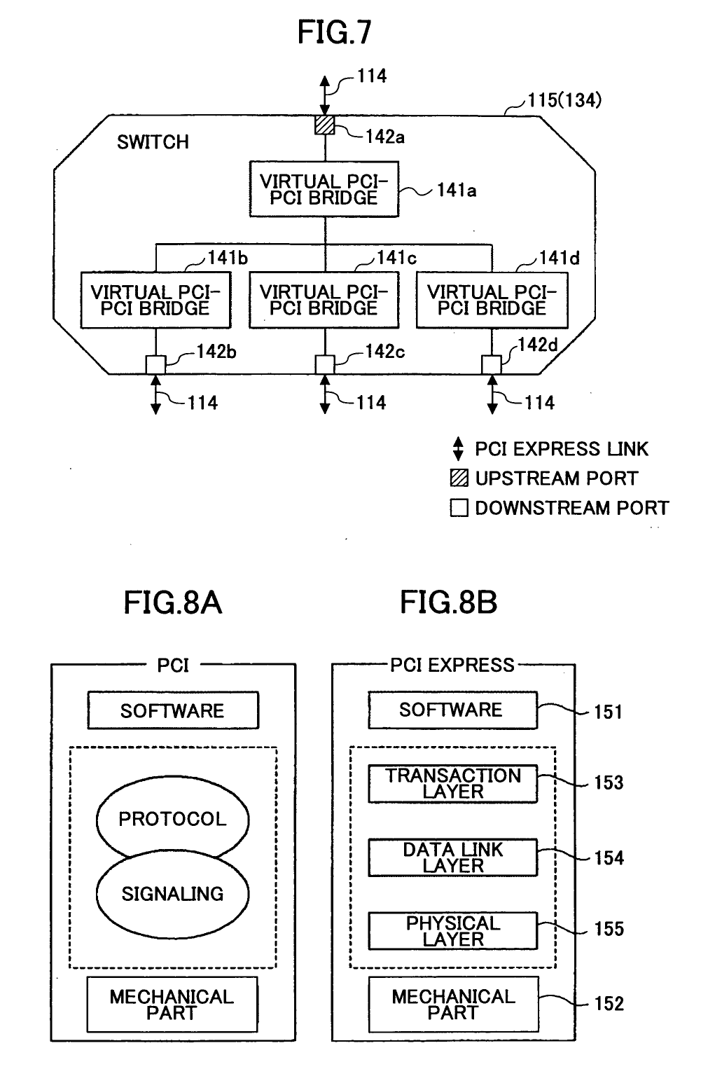

A switch (e.g., switches 117a˜117c of FIG. 3 or switch 134 of FIG. 4) is configured to connect at least two ports, and conduct packet routing between the connected ports. As is illustrated in FIG. 7, according to configuration software, the switch is perceived as a collection of virtual PCI-PCI bridges 141. It is noted that in FIG. 7, PCI Express links 114 (or PCI express links 126) are represented by arrows, and ports 142a˜142d are represented by square boxes. The port 142a corresponds to an upstream port that is positioned closer to the root complex, and ports 142b˜142d correspond to downstream ports that are positioned further away from the root complex.

E. PCI Express-PCI Bridge

In a PCI Express system, connection between the PCI Express and PCI/PCI-X devices are provided. In this way, PCI/PCI-X devices of a PCI system may be used in the PCI Express system.

(Layer Architecture)

FIG. 8A shows a structure of PCI architecture, and FIG. 8B shows a structure of PCI Express architecture. As is shown in FIG. 8A, in the PCI architecture, protocol and signaling are intimately associated with each other, but the concept of a layer structure is not incorporated into the PCI architecture. As is shown in FIG. 8B, the PCI Express architecture has a layer structure similar to that of a general communication protocol or the InfiniBand and includes independent layers each defining their individual specifications. Specifically, the PCI Express architecture of FIG. 7B includes software 151 as an uppermost layer, a mechanical part 152 as a lowermost layer, and a transaction layer 153, a data link layer 154, and a physical layer 155 provided in between the uppermost and lowermost layers. In this way, modularity of the respective layers may be psured to thereby provide scalability and enable reuse of modules. For example, upon incorporating a new signal coding method or a transmission medium, only the physical layer may have to be changed, whereas the data link layer and the transaction layer may continue to be used without adding changes thereto.

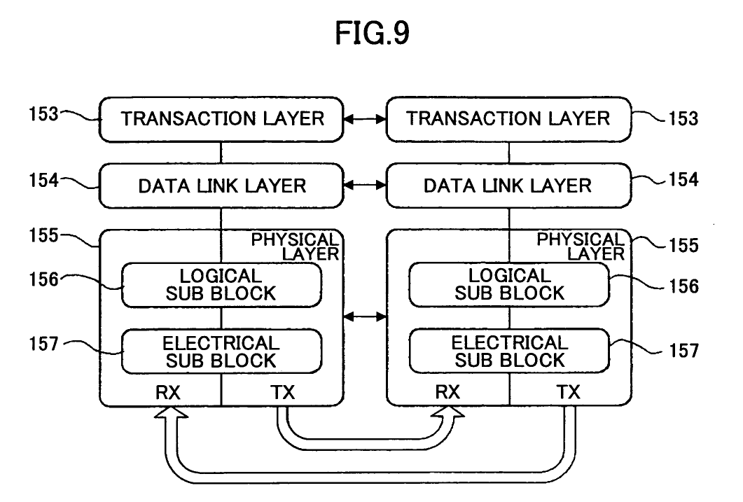

In the following, functions of the transaction layer 153, the data link layer 154, and the physical layer 155 of the PCI Express architecture are described with reference to FIG. 9.

A. Transaction Layer 153

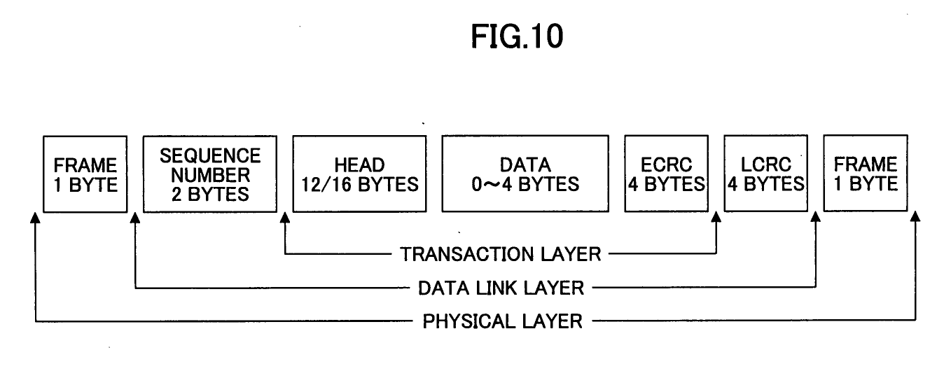

The transaction layer 153 corresponds to the uppermost layer of the three layers and is provided with functions for constructing and deconstructing a transaction layer packet (TLP). The transaction layer packet (TLP) is used for transmitting various transactions such as read/write transactions and other events. The transaction layer 153 conducts flow control using credits for the transaction layer packet (TLP). FIG. 10 is a diagram illustrating an exemplary format of a transaction packet layer (TPL) within the respective layers 153˜155.

B. Data Link Layer 154

The data link layer 154 is provided with functions for ensuring data completeness of the transaction layer packet (TLP) through error detection/correction (retransmission) and realizing link management. In the data link layer 154, packet exchange is conducted for realizing link management and flow control. It is noted that the packet used in the data link layer 154 is referred to as a data link layer packet (DLLP) to distinguish such a packet from the transaction layer packet (TLP).

C. Physical Layer 155

The physical layer 155 includes circuits required for conducting interface operations such as a driver, an input buffer, a parallel-serial/serial-parallel converter, a PLL, and an impedance matching circuit, for example. The physical layer 155 is provided with interface initialization and protection functions as logical functions. Also, the physical layer 155 has a function of dissociating the data link layer 154 and the transaction layer 153 from the signal technology used in an actual link.

It is noted that in the hardware configuration of the PCI Express, the so-called embedded clock technology is used in which a clock signal is not used, and clock timing is embedded in a data signal so that the clock timing may be extracted at a reception side based on cross points in the data signal.

(Configuration Space)

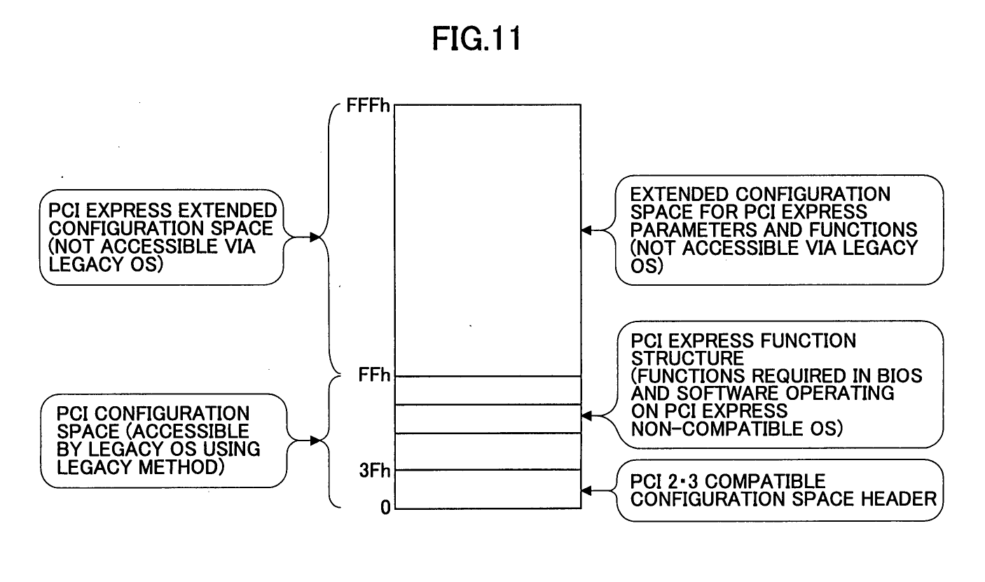

The PCI Express includes a configuration space as with the PCI. The size of the configuration space of the PCI Express is arranged to be larger than that of the PCI. Specifically, as is shown in FIG. 11, the PCI Express configuration space is extended to 4096 bytes from the 256 bytes used in the PCI. In this way, sufficient space may be secured for additional functions and devices (e.g., host bridge) requiring a large number of device specific register sets. It is noted that in the PCI Express, access to the configuration space is realized through access to a flat memory space (configuration read/write), and bus/device/function/register numbers are mapped in a memory address.

In the PCI Express configuration space, the first 256 bytes may be accessed as a PCI configuration space through the BIOS or from an OS using an I/O port, for example. Accordingly, a function of converting the access to the PCI into an access to the PCI Express is implemented in a host bridge. As is shown in FIG. 11, a PCI2.3 compatible configuration space header is provided from 00h to 3Fh. In this way, a legacy OS or software that is originally implemented may be used for accessing functions other than the functions extended by the PCI Express. Specifically, in the software layer of the PCI Express, compatibility with the PCI load-store architecture (i.e., a scheme in which a processor directly accesses an I/O register) is maintained. However, in the case of using a function extended by the PCI Express (e.g., synchronous transmission, RAS (Reliability, Availability, and Serviceability)), access has to be made to the 4 KB PCI Express extended configuration space.

It is noted that various form factors may be conceived for the PCI Express including the add-in card, the plug-in card (NewCard), and the Mini PCI Express card, for example.

(Architecture of the PCI Express)

In the following, detailed descriptions of the transaction layer 153, the data link layer 154, and the physical layer 155 of the PCI Express architecture are given.

A. Transaction Layer 153

As is described above, the transaction layer 153 is provided with functions for constructing and deconstructing a transaction layer packet (TLP) exchanged between the upper software layer 151 and the lower data link layer 154.

(a) Address Space and Transaction Type

In the PCI Express, four address spaces are defined including a memory space (for data transmission with a memory space), an I/O space (for data transmission with the I/O space), and a configuration space (for setup with a device configuration) that are also defined in the PCI; and a message space (for in-band event notification or general message transmission (exchange) between PCI Express devices, the message space allowing interrupting requests or confirmations to be transmitted as virtual wire messages) that is additionally defined in the PCI Express. It is noted that transaction types are defined by the respective address spaces (i.e., read/write transactions are defined by the memory space, the I/O space, and the configuration space define, and message transactions including vendor message transactions are defined by the massage space).

(b) Transaction Layer Packet (TLP)

The PCI Express realizes communication in packet units. Referring to the transmission layer packet (TLP) format shown in FIG. 10, a header having a length of 3 DW (12 bytes) or 4 DW (16 bytes) (DW: double word) is provided, the header including information on the format of the transaction layer packet (e.g., header length, the presence of a payload), the transaction type, the traffic class (TC), attributes, and the payload length, for example. It is noted that the maximum payload length within the packet is 1024 DW (4096 bytes).

The ECRC (End-to-end Cyclic Redundancy Checksum) is provided for ensuring end-to-end data completeness, and corresponds to a 32-bit CRC of the transaction layer packet. It is noted that when an error occurs at the transaction layer packet (TLP) within the switch, such an error may not be detected in the LCRC (link CRC) since the LCRC is recalculated at the TLP.

It is noted that a request may or may not require a complete packet.

(c) Traffic Class (TC) and Virtual Channel (VC)

Traffic class (TC) information may be used by the upper software layer to distinguish (prioritize) traffic. For example, transmission of graphic data may be prioritized over network data. It is noted that eight traffic classes TC0˜TC7 are provided.

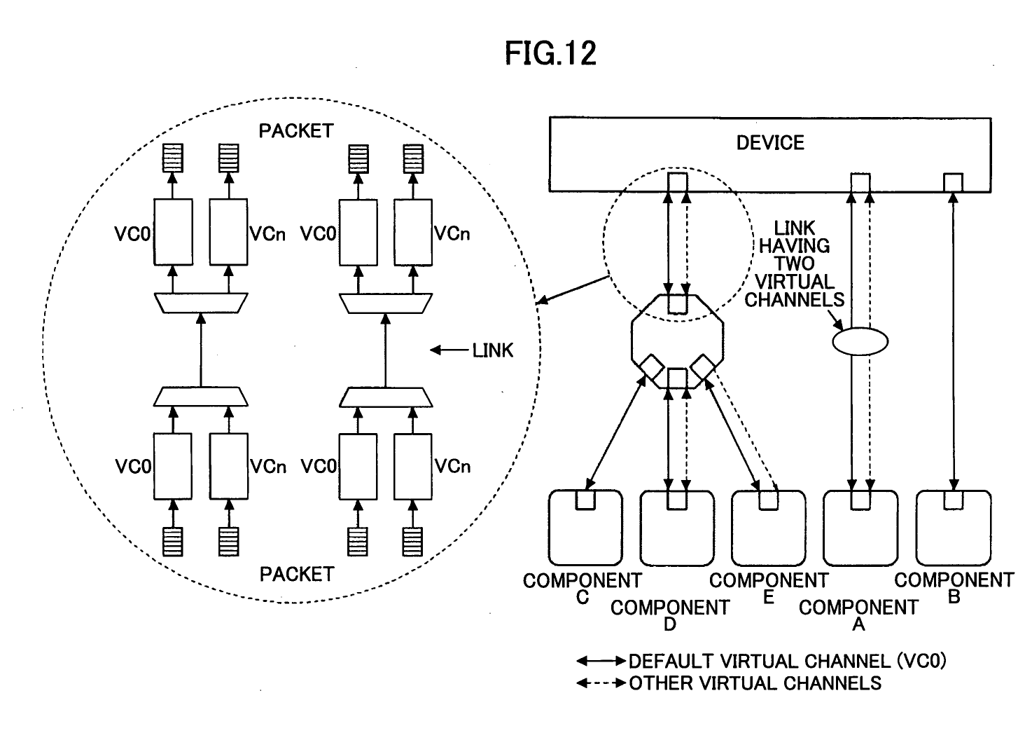

Virtual channels (VC) correspond to virtual communication buses (mechanism using plural independent data flow buffers sharing the same link) that each have resources (e.g., buffers or queues) and are arranged to conduct independent flow control operations as is illustrated in FIG. 12, for example. In this way, even when a buffer of one virtual channel is full, data transmission may be conducted using another virtual channel. In other words, by dividing one physical link into plural virtual channels, efficient use of resources may be realized. For example, as is shown in FIG. 12, when the link of a root branches out to plural devices via a switch, traffic priority for each of the devices may be controlled. It is noted that the virtual channel VC0 corresponds to a default virtual channel that is required in the system, and other virtual channels (e.g., VC1˜VC7) may be provided according to tradeoff between cost performance. In FIG. 12, the default virtual channel VC0 is indicated by solid lines, and other virtual channels (e.g., VC1˜VC7) are indicated by broken lines.

In the transaction layer 153, the traffic classes (TC) are mapped to the virtual channel(s) (VC). It is noted that one or more traffic classes (TC) may be mapped to a virtual channel according to the number of virtual channels being provided. As two simple examples, each traffic class (TC0˜TC7) may be mapped to each virtual channel (VC0˜VC7) on a one-to-one basis, or all the traffic classes (TC0˜TC7) may be mapped to a single virtual channel (VC0). It is noted that the mapping of TC0 to the virtual channel VC0 is a prerequisite, whereas the mapping of the other traffic classes (TC1˜TC7) may be controlled by the upper software layer. As is described above, the software layer may use the traffic class (TC) information to control the priority of transactions.

(d) Flow Control

It is noted that flow control (FC) is conducted in order to avoid congestion and overflow of the reception buffer, and to set a transmission order. The flow control is conducted on a point-to-point basis between links rather than on an end-to-end basis. Therefore, it may not be confirmed through such flow control that a packet has actually been received at the communication counterpart (completer).

In the PCI Express, credit-based flow control is conducted. That is, the PCI Express implements a mechanism for preventing overflow or underflow by checking the state of the buffer at the reception side before starting data transmission. More specifically, at the time of link initialization, the reception side informs the transmission side of its buffer capacity (credit value). In turn, the transmission side compares the credit value with the length of the packet it intends to send to the receiving side, and conducts the packet transmission only when the credit value exceeds the transmission packet length by a predetermined value. It is noted that six types of credits are provided.

Information exchange with respect to flow control is realized using the data link layer packet (DLLP) of the data link layer 154. It is noted that the flow control is only conducted on the transaction layer packet (TLP) so that the data link layer packet (DLLP) may be transmitted at all times (i.e., the data link layer packet is not subject to flow control).

B. Data Link Layer 154

As is described above, the data link layer 154 is provided with functions for realizing highly reliable exchange of the transaction layer packets (TLP) between two components provided over a link.

(a) Handling of the Transaction Layer Packet (TLP)

Referring to FIG. 10, at the data link layer 154, a 2-byte sequence number and a 4-byte link CRC (LCRC) are respectively attached to the front end and rear end of a transaction layer packet (TLP) received from the transaction layer 153, after which the packet is handed to the physical layer 155. The transaction layer packet (TLP) is stored in a retry buffer until reception confirmation (ACK) is received from the reception side. When the transmission of the transaction layer packet successively fails, it may be determined that there is a link abnormality, and a link retraining request may be sent to the physical layer 155. When link training failure is detected, the data link layer 154 is switched to an inactive state.

On the other hand, with respect to a transmission layer packet (TLP) received from the physical layer 155, the sequence number and the link CRC (LCRC) of the transaction layer packet (TLP) from the physical layer 155 are evaluated at the data link layer 154, and the transaction layer packet (TLP) is handed to the transaction layer 153 if no abnormalities are detected. If an error is detected, a retransmission request is sent to the physical layer 155.

(b) Data Link Layer Packet (DLLP)

A packet generated by the data link layer 154 is referred to as a data link layer packet (DLLP) and is exchanged within the data link layer 154. It is noted that the following types of data link layer packets (DLLP) are provided:
Ack/Nak DLLP: for TLP reception confirmation/retry (retransmission)
InitFC1/InitFC2/UpdateFC DLLP: for flow control initialization and updating
DLLP for power management

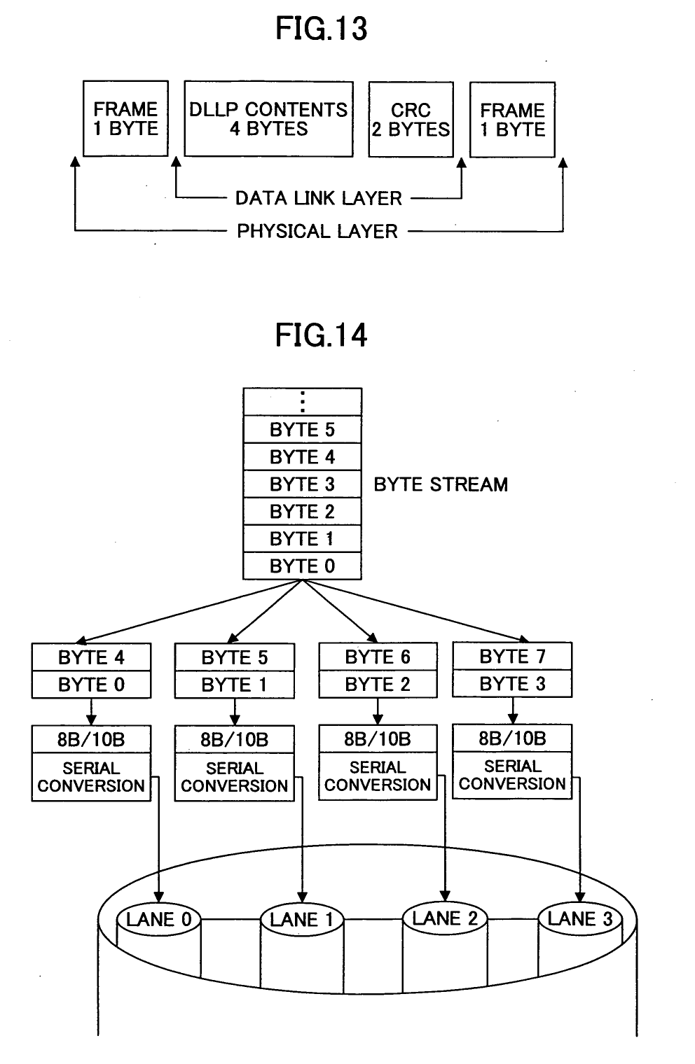

FIG. 13 is a diagram showing an exemplary format of a data link layer packet (DLLP). As is shown in this drawing, the data link layer packet has a packet length of 6 bytes, and includes information indicating the type of DLLP (1 byte), unique information in conjunction with the type of DLLP (3 bytes), and CRC (2 bytes).

C. Physical Layer-Logical Sub Block 156

Referring to FIG. 9, the physical layer 155 includes a logical sub block 156. The primary task of the logical sub block 156 of the physical layer 155 is to convert a packet received from the data link layer 154 into a format suited for transmission by an electrical sub block 157. Also, the logical sub block 156 has the function of controlling and managing the physical layer 155.

(a) Data Coding and Parallel-to-Serial Conversion

The PCI Express uses 8B/10B conversion for data coding so that long successions of ‘0’s and ‘1’s do not occur (i.e., so that an absence of cross points does not last for a long period of time). FIG. 14 illustrates byte striping of data in a x4 link. As is illustrated in FIG. 14, the converted data are serially converted to be transmitted from an LSB onto a lane. In a case where plural lanes are provided (e.g., FIG. 14 illustrates a x4 link), data are assigned to the respective lanes in byte units before being encoded. It is noted that the illustrated example appears to correspond to a parallel bus transmission; however, an independent transmission is realized in each of the lanes so that problems such as skew that are created in the parallel bus may be alleviated.

(b) Power Management and Link State

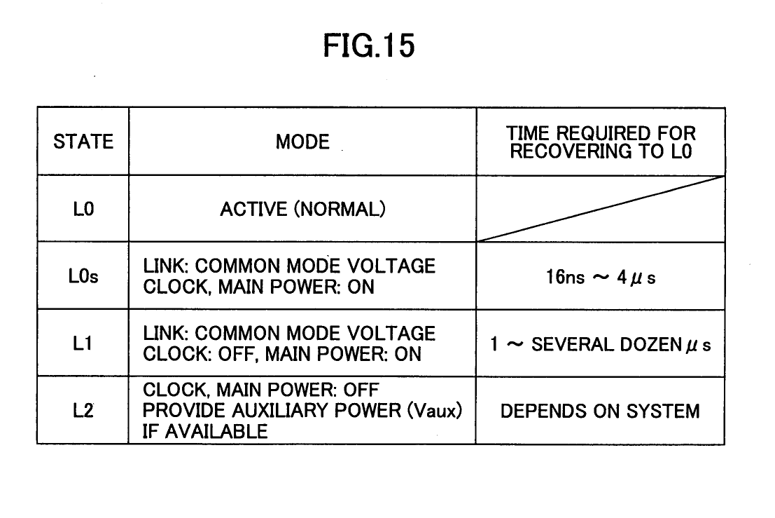

As is shown in FIG. 15, link states L0, L0s, L1, and L2 are defined for reducing the link power consumption.

According to FIG. 15, the link state L0 corresponds to a normal mode, and the link states L0s through L2 correspond to reduced power consumption modes in different degrees. It is noted that more recovery time is required for recovering back to normal mode (L0) as the degree of reduction in power consumption is increased. Also, it is noted that the recovery time from the link state L2 to the link state L0 may depend on factors such as the rise time of a power source or a PLL in the system, for example.

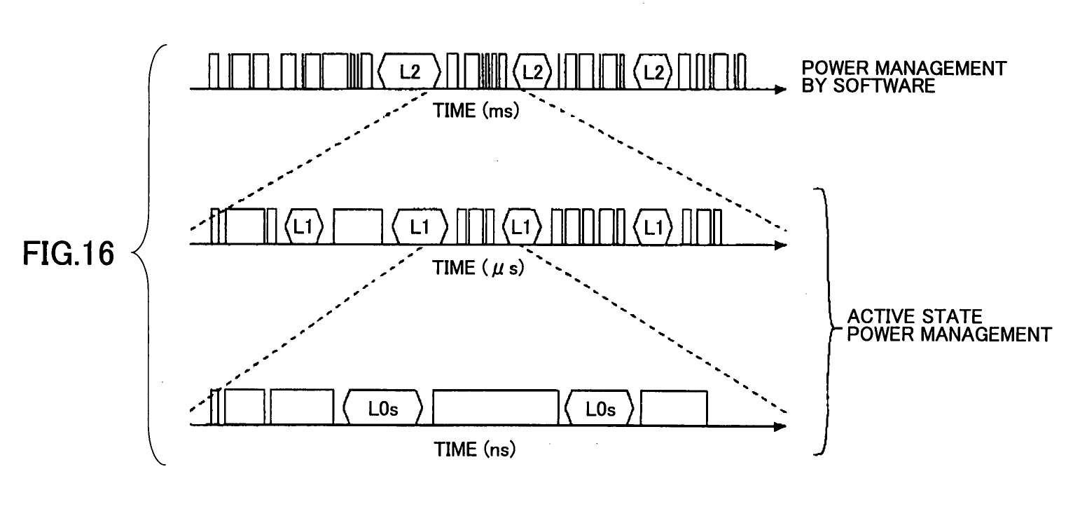

Also, as is shown in FIG. 16, power consumption may be reduced by conducting active state power management in addition to power management by software.

D. Physical Layer—Electrical Sub Block 157

As is shown in FIG. 9, the physical layer 155 includes an electrical sub block 157. The primary tasks of the electrical sub block 157 are to transmit data serially converted by the logical sub block 156 to a lane, and receive data from a lane to hand the data to the logical sub block 156.

(a) AC Coupling

It is noted that an AC coupling condenser is provided at the transmission side of a link. In this way, the DC common mode voltages of the transmission side and the reception side do not necessarily have to be the same. Thereby, differing structures, semiconductor processes, and power voltages may be used at the transmission side and the reception side.

(b) De-Emphasis

As is described above, in the PCI Express, 8B/10B encoding is conducted in order to reduce successive occurrences of ‘0’s and ‘1’s. However, successions of ‘0’s or ‘1’s may still occur (e.g., five times at the maximum). In such case, the transmission side conducts de-emphasis transmission. When bits of the same polarity occur in a succession, the differential voltage level (amplitude) is decreased by 3.5±0.5 dB for the psond bit and onward in the succession in order to psure the noise margin of the signal being received at the reception side. Such a process is referred to as de-emphasis. Owing to the frequency dependency attenuation of the transmission channel, when a bit is different from the previous bit, a large amount of high frequency components occur, and the waveform received at the reception side is reduced in size due to the attenuation. On the other hand, when a bit is not different from the previous bit, high frequency components are reduced, and a relatively larger waveform is received at the reception side. Accordingly, de-emphasis is conducted in order to maintain consistency in the waveform received at the reception side.

(Imaging System)

According to an embodiment of the present invention, an imaging system such as a scanner, a printer, a digital printer, or a MFP uses a high-speed serial bus according to the PCI Express standard as is described above as an interface between devices of the imaging system.

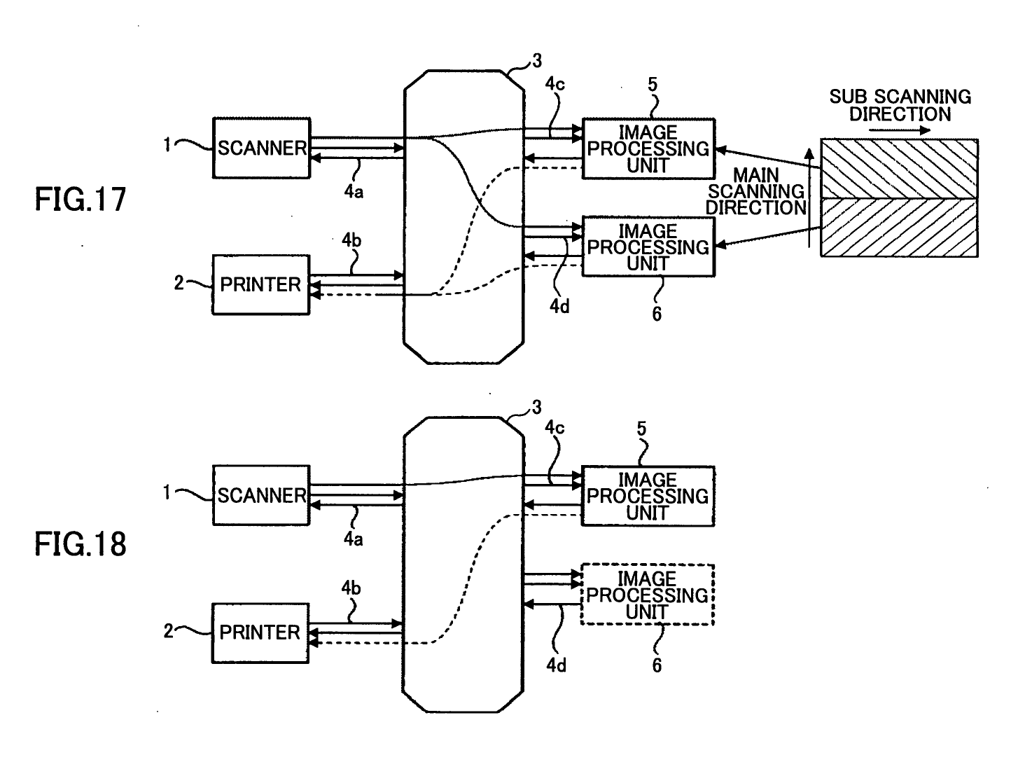

FIG. 17 is a block diagram showing an exemplary structure of an imaging system according to an embodiment of the present invention. The imaging system shown in FIG. 17 includes a scanner 1 for acquiring image data, and a printer 2 for outputting a print image based on the acquired image data. It is noted that the scanner 1 and the printer 2 may correspond to separate devices within the imaging system˜according to one embodiment, or the scanner 1 and the printer 2 may be integrally provided within the imaging system according to another embodiment as in the case of a digital copier or a MFP, for example. The printer 2 may correspond to a laser printer that is capable of realizing high-speed printing, for example. However, the present invention is not limited to a particular printing method. Also, the imaging system according to an embodiment may also correspond to a scanner or a printer including either one of the scanner 1 or the printer 2, for example.

In the illustrated example of FIG. 17, the scanner 1 and the printer 2 as end point devices of a PCI Express system are connected to a PCI Express switch 3 via PCI Express high-speed serial interfaces 4a and 4b, respectively.

Also, image processing units 5 and 6 are provided as end point devices that are connected to the PCI Express switch 3 via PCI Express high-speed serial interfaces 4c and 4d, respectively. The image processing units 5 and 6 may correspond to standard DSPs (digital signal processors) with identical image processing functions, for example. It is noted that the image processing units 5 and 6 do not require particularly advanced image processing functions and may correspond to general-purpose processors with standard image processing functions.

Also, it is noted that a root complex (not shown) that is connected to a CPU and a system memory, for example, is connected to an upstream port of the switch 3 of the present PCI Express system.

According to the present embodiment, image data of a document that are read by the scanner 1 may be transmitted at high speed via the high-speed serial interface 4a, the switch 3, the high-speed serial interfaces 4c and 4d, to the image processing units 5 and 6. In this way, image processes for the image data may be divided and assigned to the respective image processing units 5 and 6 that may conduct the image processes simultaneously in a parallel manner. Then, the image data processed by the image processing units 5 and 6 in a parallel manner may be transmitted at high speed via the high-speed serial interfaces 4c and 4d, the switch 3, and the high-speed serial interface 4b to the printer 2 where the processed image data may be combined and output (printed) on recording paper. It is noted that in the illustrated example of FIG. 17, two image processing units 5 and 6 are provided; however the number of image processing units provided in the PCI Express system may be suitably adjusted according to required image processes, and the PCI Express system may be easily adapt to adjustments made in the number of image processing units owing to scalability provided in the switch 3.

When plural image processing units 5 and 6 with identical standard image processing functions are used as in the present example, the number of image processing units provided in the imaging system may be suitably adjusted according to the image processes required by the imaging system and the image processes may be conducted in a parallel manner so that processing speed may be maintained even when high speed processing is required.

In one specific example, when a document to be read by the scanner 1 corresponds to a relatively large paper sheet so that the image processing functions of one image processing unit 5 or 6 may not be sufficient for realizing the required image processes for the document, the document to be read by the scanner 1 may be divided into two with respect to the main scanning direction of the document as is shown in FIG. 17. In the present example, the right half portion of the document (top half portion of the document shown in FIG. 17) is assigned to the image processing unit 5 while the left half portion of the document (bottom half portion of the document shown in FIG. 17) is assigned to the image processing unit 6, and image processes are simultaneously conducted at the respective image processing units 5 and 6 in a parallel manner. In this way, the amount of image data to be processed at each of the image processing units 5 and 6 may substantially be reduced by half, and the processing speed may be maintained at a high speed by the parallel processing.

In another example, when image processing at a relatively high resolution is requested, the image processing functions of one image processing unit 5 or 6 may not be sufficient for realizing the required image processes, and thereby the document to be read by the scanner 1 may be divided into two with respect to the main scanning direction, the right half portion of the document being assigned to the image processing unit 5, and the left half portion of the document being assigned to the image processing unit 6, for example, to realize image processes at the respective image processing units 5 and 6 in a parallel manner. In this way, the image density of the image to be processed at each of the image processing units 5 and 6 may substantially be reduced by half, and the processing speed may be maintained at a high speed by the parallel processing.

Referring to FIG. 18, in another example, when a document to be read by the scanner 1 corresponds to a normal size paper sheet or a smaller size paper sheet, the image processing functions of one image processing unit 5 or 6 may be sufficient for realizing the required image processes. In such a case, only the image processing unit 5 may be activated while the image processing unit 6 may be left in inactivated. That is, according to an embodiment, the image processing units 5 and 6 may be selectively activated according to the required image processes. In this way, the inactivated image processing unit may be in a power conservation mode so that the overall power consumption may be reduced. Similarly, when image processing at a normal resolution or lower is requested, the image processing functions of one image processing unit 5 or 6 may be sufficient for realizing the required image processes. Thereby, the image processing units 5 or 6 may be selectively activated as is described above. For example, the image processing unit 5 may be activated while the image processing unit 6 may be left inactivated. In this way, the inactivated image processing unit may be in a power conservation mode so that the overall power consumption may be reduced.

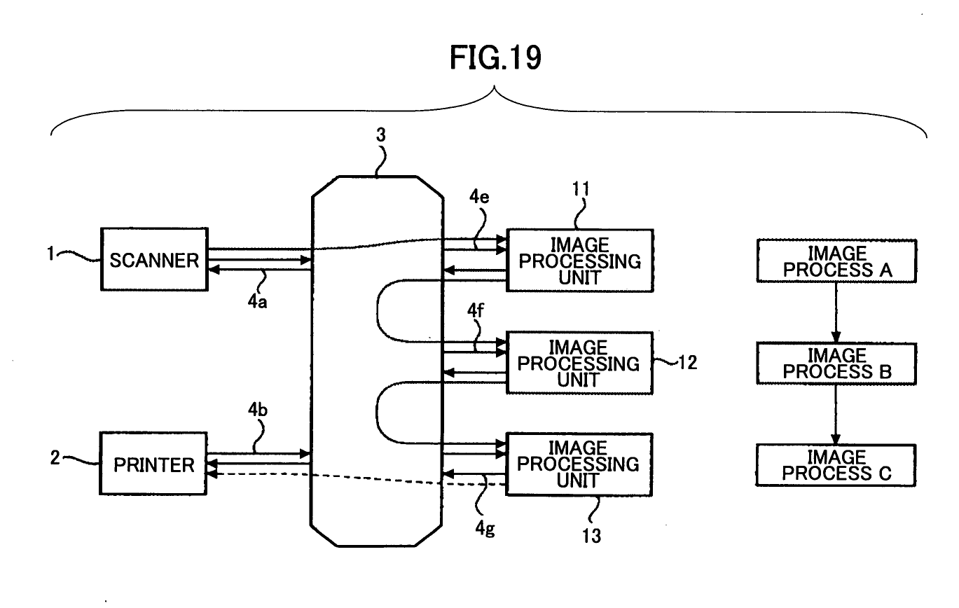

FIG. 19 is a block diagram showing an exemplary structure of an imaging system according to another embodiment of the present invention. It is noted that the basic structure of the imaging system of FIG. 19 corresponds to that shown in FIG. 17. However, in the present example, three image processing units 11, 12, and 13 are provided as end point devices of the imaging system, the image processing units 11, 12, and 13 being connected to a PCI Express switch 3 via PCI Express high-speed serial interfaces 4e, 4f, and 4g, respectively. According to the present embodiment, the image processing 11, 12, and 13 may correspond to digital signal processors (DSP) each having differing image processing functions (e.g., image processes A, B, and C). For example, the image process A may correspond to basic image processes, and the image process B may correspond to image rotation processes. It is noted that the image processing units 11, 12, and 13 do not require particularly advanced image processing functions as is described above.

As is shown in FIG. 19, according to the present embodiment, image data read from a document by the scanner 1 may be transmitted at high speed via the high speed serial interface 4a, the switch 3, and the high-speed serial interface 4e to the image processing unit 11 at which the image process A is conducted. Then, the image data on which the image process A has been conducted may be transmitted at high-speed from the image processing unit 11 via the high-speed serial interface 4e, the switch 3, and the high-speed serial interface 4f to the image processing unit 12 at which the image process B is conducted. Then, the image data on which the image process B has been conducted may be transmitted at high-speed from the image processing unit 12 via the high-speed serial interface 4f, the switch 3, and the high-speed serial interface 4g to the image processing unit 13 at which the image process C is conducted. In this way image data may be passed on (relayed) to the image processing units 11, 12, and 13, through a pipeline-like flow path to realizing image processes on the image data in an efficient manner. Then, the image data processed by the image processing unit 13 are transmitted at high speed via the high-speed serial interface 4g, the switch 3, and the high-speed serial interface 4b to the printer 2 so that the processed image data may be printed (output) on recording paper. It is noted that in the illustrated example, three image processing units 11, 12, and 13 are shown; however, the number of image processing units may be adjusted according to the required image processes. The PCI Express system is able to easily adapt to an increase/decrease of the number of image processes owing to scalability provided in the switch 3. For example, image processes A and C may be provided as legacy image processing functions that are initially provided in the system, and the image process B as a new image processing function may be provided at a later stage. In such a case, the image processing unit 12 may be additionally connected to the switch 3 of the imaging system to enable execution of the image process B. In this way, high flexibility may be realized in the imaging system.

(Digital Copier)

In the following, a digital copier according to an embodiment of the present invention is described.

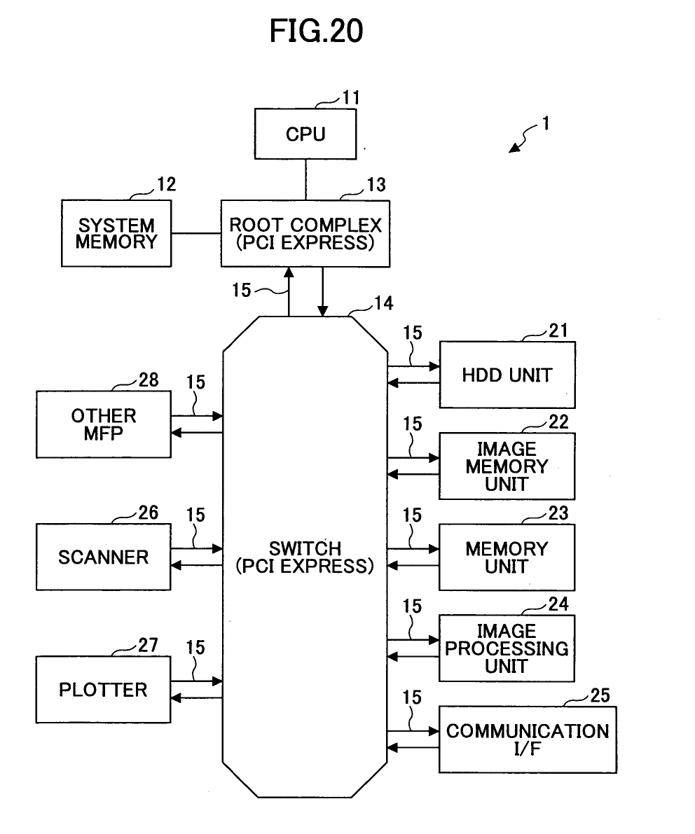

FIG. 20 is a block diagram showing connections between devices of a digital copier 1 according to an embodiment of the present invention. The digital copier 1 corresponds to an image processing apparatus that is configured to conduct predetermined processes on image data. For example, the digital copier 1 may correspond to a so-called multifunction printer (MFP) that is configured to conduct processes such as reading a document image and forming a corresponding image on recording paper.

The digital copier 1 of the present embodiment uses a bus system according to the PCI Express standard for realizing data transmission. Specifically, in the digital copier 1, a CPU that controls the units of the digital copier 1, and a system memory 12 used as a working area for the CPU 11 are connected to a PCI Express root complex 13. The root complex 13 is connected to a PCI Express switch (or switch network) 14 via a PCI Express general-purpose bus 15. The PCI Express-base switch (or switch network) 14 is connected to various units corresponding to PCI Express end point devices such as a hard disk drive (HDD) unit 21, an image memory unit 22, and a memory unit for temporarily storing data such as image data; an image processing unit 24 for conducting various image processes; a communication interface (I/F) 25 such as a high-speed network G-Ethernet unit for establishing communication with external networks; a scanner 26; a plotter 27; and other multifunction printers (MFP) 28.

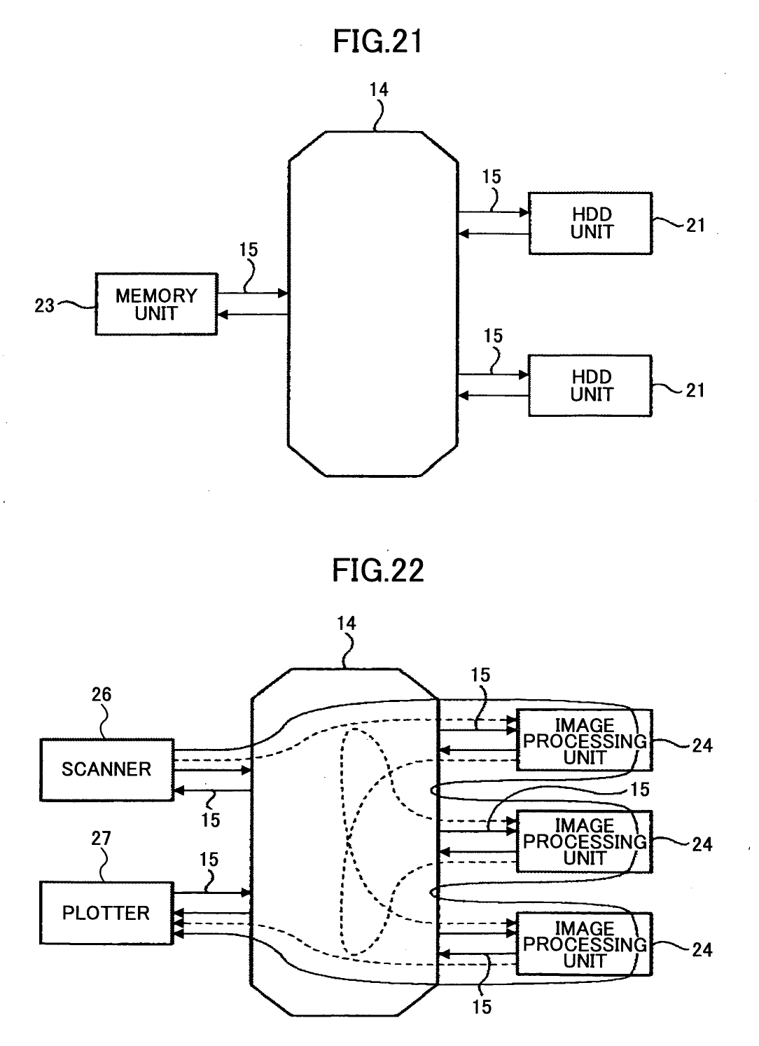

In the following, the connection between the HDD unit 21 and the switch (or a network of plural switches, simply referred to as switch hereinafter) 14 is described with reference to FIG. 21. As is shown in FIG. 21, plural HDD units 21 may be connected to the switch (or switch network) 14. Also, one or two HDD units 21 may initially be connected to the switch 14, and one or more additional HDD units 21 may be connected to the switch 14 at a later stage. Each of the HDD units 21 connected to the switch 14 is arranged to conduct a RAID (Redundant Arrays of Independent/Inexpensive Disks) operation.

It is noted that by using the PCI Express bus system and arranging the HDD units 21 to conduct RAID operations, a decrease in productivity of the digital copier 1 due to a bandwidth limitation of the HDD units may be prevented. According to the present example, the HDD unit 21 may be additionally implemented so that the performance of HDD units 21 may be improved.

Next, referring to FIG. 22, the connection between the image processing unit 24 and the switch 14 is described. As is shown in FIG. 22, plural image processing units 24 may be connected to the switch 14. Also, one or two image processing units 24 may initially be connected to the switch 14, and one or more additional image processing units 24 may be connected to the switch 14 at a later stage.

According to an embodiment, plural image processing units 24 that are configured to conduct the same image processes may be implemented to realize image processing at high speed. According to another embodiment, one or more image processing units 24 that are configured to conduct image processes that are different from the image processes arranged to be conducted by existing image processing units 24 may be additionally implemented.

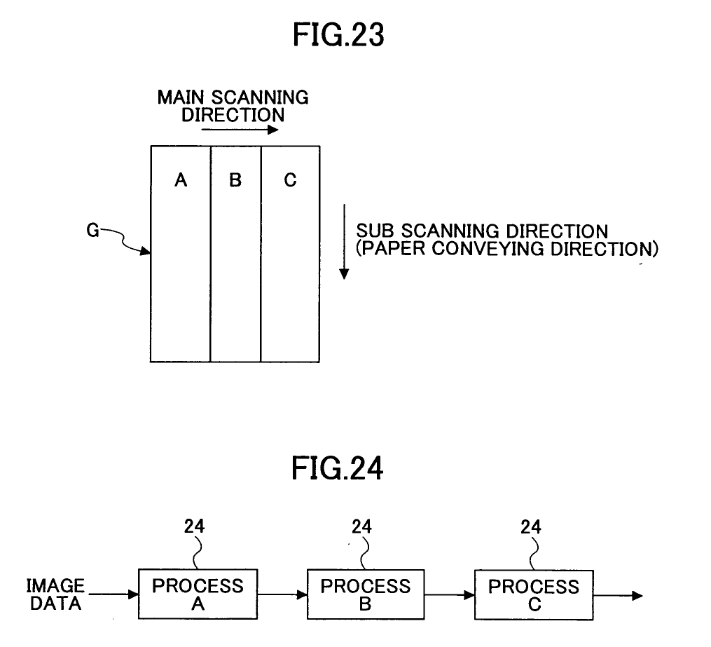

In the following, specific examples of image processing operations are described with reference to FIGS. 23 and 24.

FIG. 23 illustrates an exemplary operation for realizing high speed image processing using three image processing units 24 that are arranged to conduct the same types of image processes. According to the present example, document image data G read by a scanner 26 are processed by the image processing units 24, after which the processed image data are output to a plotter 27. In this case, the image data G are divided into three pstions A, B, and C with respect to the main scanning direction, and the image processing units 24 are respectively assigned to conduct image processes on the image data sections A, B, and C simultaneously to realize high-speed image processing.

FIG. 24 illustrates an example in which three image processing units 24 that are configured to conduct differing image processes (i.e., process A, process B, and process C) are used. According to the present example, document image data G read by a scanner 26 are successively processed by the image processing units 24 that are configured to conduct differing processes A, B, and C, respectively. In the present example, two image processing units 24 configured to conduct processes A and B, respectively, may initially be implemented, and a new image processing unit 24 configured to conduct the process C may be added to enable execution of the process C on the image data in addition to the processes A and B.

In the following, various advantages achieved by embodiments of the present invention are described.

According to an embodiment of the present invention, plural independent image processing units as endpoint devices of a tree structure of a PCI Express high-speed serial interface system are connected by PCI Express high-speed serial interfaces. In this way, advantageous features of the PCI Express high-speed serial interface system including high-speed serial communication, scalability, and protocol flexibility may be realized. Particularly, when the PCI Express switch is used, high scalability maybe realized. Also, by arranging the image processing units to be simultaneously/selectively activated, or by arranging image data to be passed on (relayed) via the PCI Express high-speed serial interfaces to be successively processed by the image processing units, image processing functions may be used in an efficient manner. Thereby, the image processing units may not have to be designed in accordance with the maximum performance or capability of the imaging system, and versatility and flexibility may be provided in the imaging system.

Particularly, when plural image processing units with identical standard image processing functions are used, the number of processing units to be used in a specific imaging operation may be adjusted according to the image processing requirements or conditions for the specific imaging operation. In a case where high resolution image processing is required, for example, parallel (simultaneous) processing may be realized by the image processing units so that the processing speed may be maintained. Also, in this case, general-purpose image processing units with standard image processing functions may be used instead of using a dedicated image processing unit that is expensive and lacks flexibility so that an inexpensive imaging system provided with versatility and flexibility may be realized.

In another embodiment, plural image processing units with differing image processing functions may be provided, and image data to be processes may be passed on via the PCI Express high-speed serial interface system to be successively (serially) processed by the image processing units in an efficient manner. Thereby, the image processing units do not have to be designed in accordance with the maximum performance or capabilities of the imaging system and desired imaging processes may be conducted at high speed in a flexible manner.

According to another embodiment of the present invention, plural magnetic storage devices as PCI Express end point devices are provided so that a decrease in productivity of an image processing apparatus due to bandwidth limitations of the magnetic storage devices may be prevented by the RAID operations conducted by the magnetic storage devices. Also, since magnetic storage devices may be additionally implemented, the performance of the magnetic storage devices may be improved by the additional implementation of the magnetic storage devices.

According to an embodiment of the present invention, plural image processing circuits that are configured to conduct the same image processes may be used to realize high-speed image processing. Also, an image processing circuit configured to conduct an image process that is different from those of existing image processing circuits may be additionally implemented.

Further, it is noted that the present invention is not limited to the specific embodiments described above, and variations and modifications may be made without departing from the scope of the present invention.

The present application is based on and claims the benefit of the earlier filing date of Japanese Patent Application No.2004-139696 filed on May 10, 2004, and Japanese Patent Application No.2004-168552 filed on Jun. 7, 2004, the entire contents of which are hereby incorporated by reference.

1. An imaging system that implements a PCI Express high-speed serial interface system in which a plurality of point-to-point simplex communication channels are established to realize a data communication network having a tree structure, the imaging system comprising:
a PCI Express high-speed serial interface; and
a plurality of independent image processing units as end point devices of the tree structure that are connected by the PCI Express high-speed serial interface.

2. The imaging system as claimed in claim 1, further comprising:
at least one of a scanner for reading image data and a printer for outputting a printed image based on the image data as another end point device of the tree structure that is connected by the PCI Express high-speed serial interface.

3. The imaging system as claimed in claim 2, further comprising:
a PCI Express switch to which the image processing units and the at least one of the scanner and the printer are connected by the PCI Express high-speed serial interface.

4. The imaging system as claimed in claim 1, wherein
the imaging units are configured to have identical image processing functions.

5. The imaging system as claimed in claim 4, wherein
the image processing units are simultaneously activated or selectively activated depending on an image processing condition.

6. The imaging system as claimed in claim 5, wherein
the imaging units are simultaneously activated in a case where a relatively large image is subject to image processing.

7. The imaging system as claimed in claim 5, wherein
the image processing units are simultaneously activated in a case where image processing at a relatively high resolution is to be conducted.

8. The imaging system as claimed in claim 6, wherein
image data subject to image processing are divided into image data sections with respect to a main scanning direction, and the image data sections are simultaneously processed by the image processing units.

9. The imaging system as claimed in claim 7, wherein
image data subject to image processing are divided into image data sections with respect to a main scanning direction, and the image data sections are simultaneously processed by the image processing units.

10. The imaging system as claimed in claim 1, wherein
the image processing units are configured to have differing image processing functions; and
image data subject to image processing are relayed via the PCI Express high-speed serial interface and successively processed by the image processing units.

11. An image processing apparatus that is configured to conduct predetermined processes on image data, the apparatus comprising:
a PCI Express bus and a PCI Express switch for realizing data transmission; and
a plurality of magnetic storage devices corresponding to PCI Express end point devices that are connected to the PCI Express switch.

12. An image processing apparatus that is configured to conduct predetermined image processes on image data, the apparatus comprising:
a PCI Express bus and a PCI Express switch for realizing data transmission; and
a plurality of image processing circuits corresponding to PCI Express end points that are connected to the PCI Express switch.

13. The image processing apparatus as claimed in claim 12, wherein
the image processing circuits are configured to conduct a same type of image process.

14. The image processing apparatus as claimed in claim 12, wherein
the image processing circuits are configured to conduct different types of image processes.
